(19) United States
(12) Patent Application Publication
(10) Pub. No.: US 2021/0206104 A1
(43) Pub. Date: Jul. 8, 2021

(54) BUILD UNIT FOR THREE-DIMENSIONAL PRINTER

(71) Applicant: HEWLETT-PACKARD DEVELOPMENT COMPANY, L.P., Spring, TX (US)

(72) Inventors: Alexander LAWS, Vancouver, WA (US); Tait A. REGNIER, Vancouver, WA (US); Joshua CODER, Vancouver, WA (US)

(73) Assignee: HEWLETT-PACKARD DEVELOPMENT COMPANY, L.P., Spring, TX (US)

(21) Appl. No.: 16/075,703

(22) PCT Filed: Jul. 17, 2017
(86) PCT No.: PCT/US2017/042429

§ 371 Date: Aug. 6, 2018

(51) Int. Cl. B29C 64/364; B29C 64/153; B29C 64/25; B29C 64/245

(52) U.S. Cl. CPC B29C 64/364; B29C 64/153; B33Y 30/00; B29C 64/245; B29C 64/25

(57) ABSTRACT

According to one aspect, there is provided a build unit for a 3D printer. The build unit comprises a housing and a build platform movable with the housing, the housing and the platform forming a build chamber. An upper portion of the housing is to, during a print operation, maintain the contents of the upper portion of the build chamber within a first predetermined temperature range, whereas the lower portion of the housing is to allow cooling of the contents of a lower portion of the build chamber.

### BACKGROUND

Additive manufacturing, commonly referred to as three-dimensional or 3D printing, enables objects to be generated on a layer-by-layer basis, for example through the selective solidification of a build material.

Powder-based 3D printing systems, for example, typically form successive thin layers of a powder or particulate-type build material on a build platform within a build chamber and selectively solidify portions of each layer that represent a cross-section of a 3D object. Selective solidification techniques may include, for example, use of a printable fusing agent in combination with application of fusing energy to cause portions of the build material on which fusing agent is printed, or applied, to absorb more energy than portions of build material on which no fusing agent is printed. The portions on which fusing agent is printed melt, fuse, and solidify to form part of the 3D object being printed, whereas non-fused build material remains in a generally non-solidified state and may be removed and, in some cases, reused in the generation of further 3D objects. Other 3D printing systems, such as selective laser sintering (SLS) systems, may use a laser to selectively sinter, melt, or fuse portions of a layer of build material.

### BRIEF DESCRIPTION

Examples will now be described, by way of non-limiting example only, with reference to the accompanying drawings, in which:

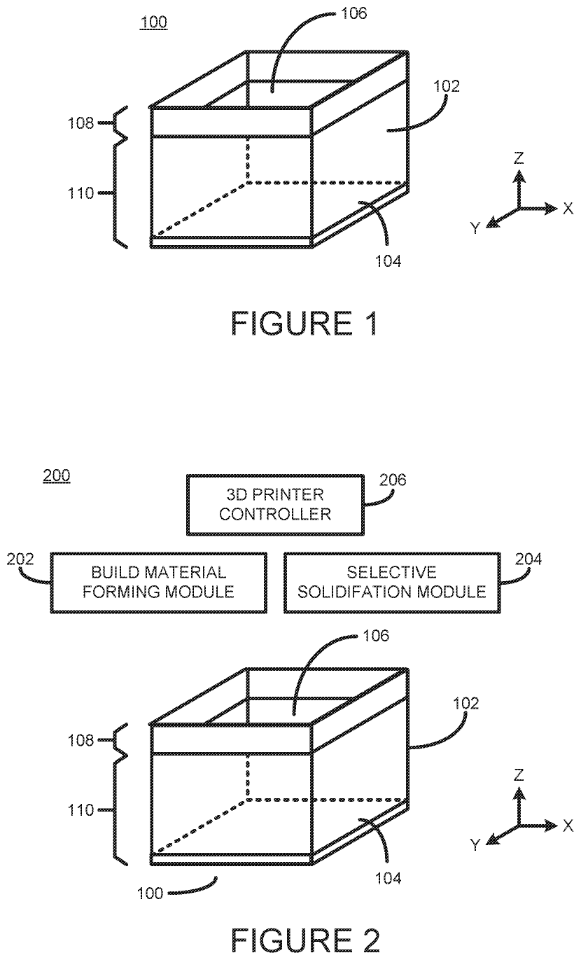

FIG. 1 shows a simplified illustration of a build unit according to one example;

FIG. 2 shows a simplified illustration of a 3D printer having a build unit according to one example;

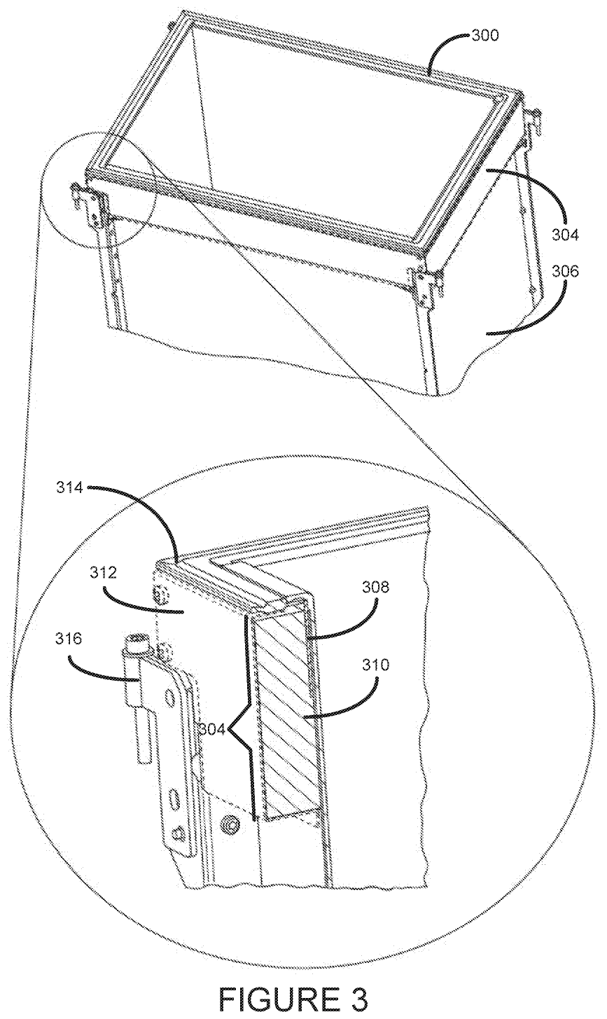

FIG. 3 shows a portion of a build unit according to one example;

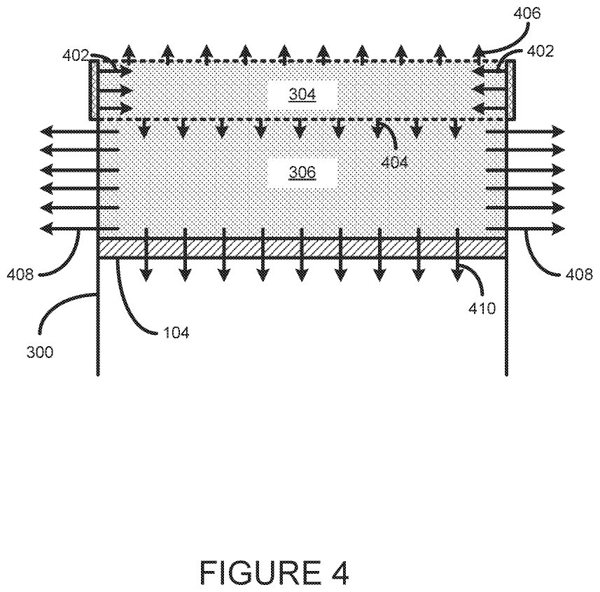

FIG. 4 is a drawing illustrating heat flow within a build unit according to one example;

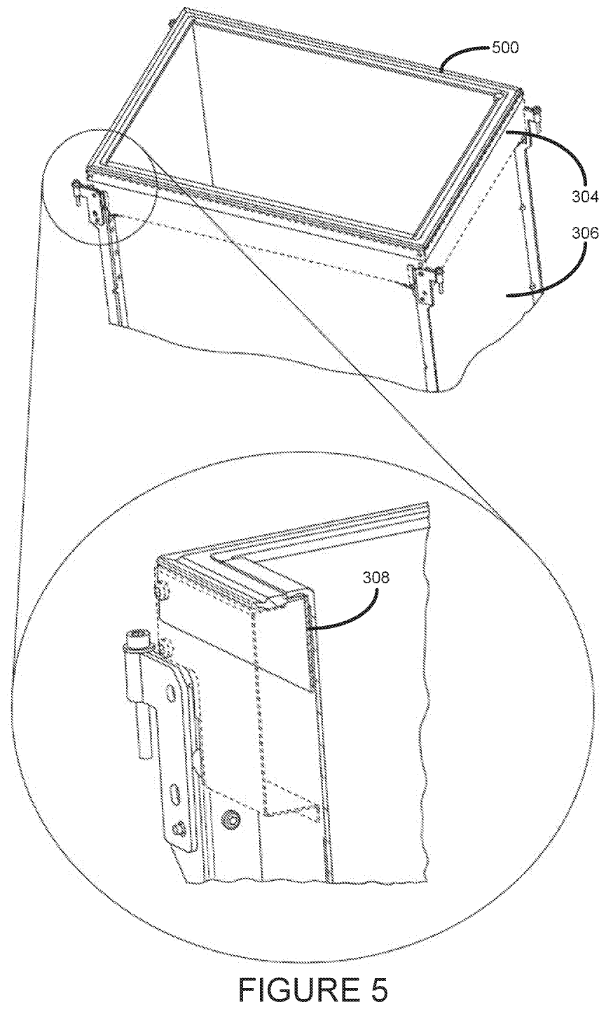

FIG. 5 shows a portion of a build unit according to one example;

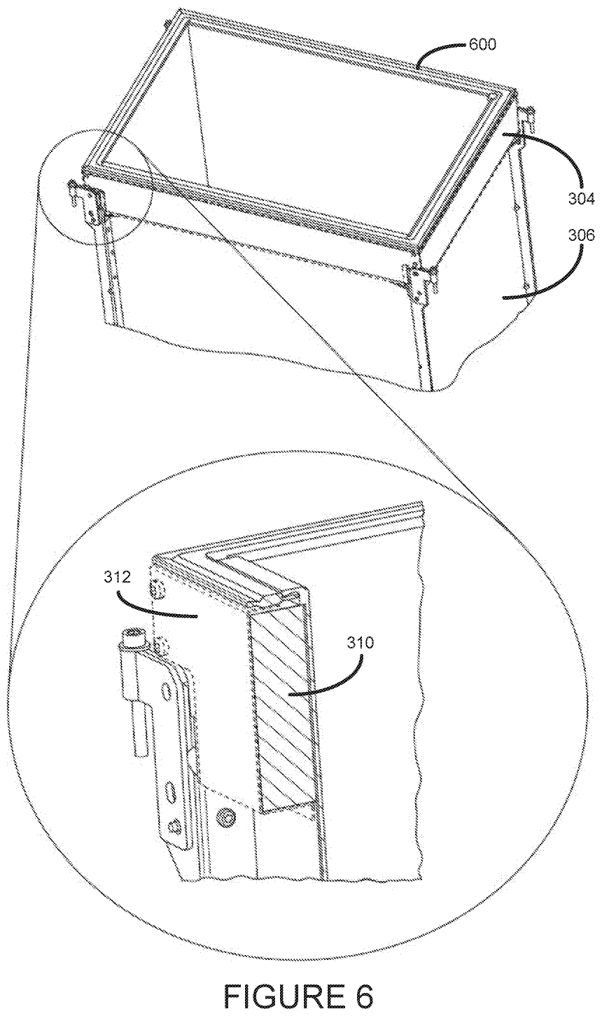

FIG. 6 shows a portion of a build unit according to one example; and

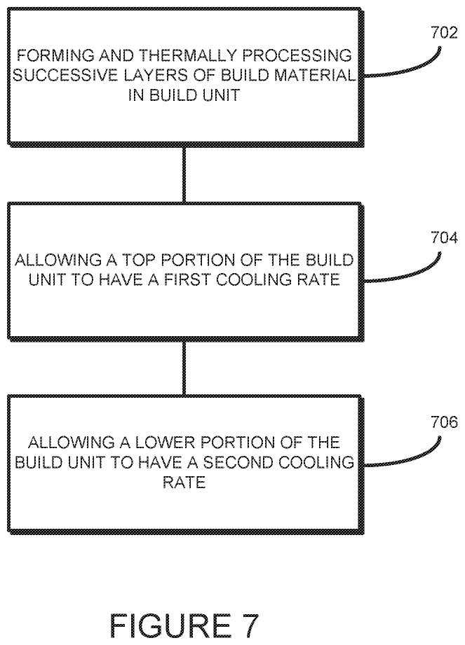

FIG. 7 is a flow diagram outlining a method of operating a 3D printing system according to one example.

### DETAILED DESCRIPTION

In thermal fusing or sintering based 3D printing systems portions of successive layers of build material formed on a build platform are selectively solidified by applying thermal energy. The application of thermal energy causes selective portions of each layer of build material to fuse, melt, or sinter.

In selective laser sintering systems (SLS) a focused laser beam is used to apply thermal energy to specific portions of each of layer of a build material to cause fusing or sintering.

In fusing agent based 3D printing systems, an energy absorbing agent may be printed on specific portions of each layer of a build material and a non-focused energy source, such as a halogen lamp, may apply energy generally substantially uniformly to each layer of build material. Those portions on the build material on which fusing agent is applied absorb sufficient energy to cause those portions to fuse or melt, whereas those portions on which no fusing agent is applied will generally not absorb sufficient energy to cause those portions to fuse or melt.

Upon cooling, the portions which fused, melted, or sintered solidify to form part of the 3D object being generated. To ensure high quality 3D printed objects, the temperature to which build material is raised into order to be satisfactorily fused has to be carefully controlled. However, the rate at which generated 3D objects are cooled also plays a role in object quality. For example, for some build materials at least, a too rapid cooling may induce undesirable internal stresses into 3D printed objects. Such stresses may, for example, cause 3D printed objects, or processed layers thereof, to curl, deform, or have some other undesirable propefties. An excessively slow cooling time may increase the length of time before which printed 3D objects may be made available for use after printing and may also degrade at least some mechanical properties. An appropriate cooling of 3D printed objects may thus favorise 3D printed objects to have high part quality, for example having high dimensional accuracy, high interlayer strength, or the like, and may help reduce the delay before which 3D printed objects may be available for use after printing.

Referring now to FIG. 1, there is shown a build unit 100 for use in a 3D printing system according to an example.

The build unit 100 comprises connected sidewalls 102 which form a generally open-topped housing having a rectangular-shaped base. A movable build platform 104 is also provided which is movable vertically within the build unit 100. The sidewalls and build platform form a build chamber 106. Layers of build material may be formed on the build platform 104 and processed to form a 3D object within the build chamber 106. After each layer of powder is processed the build platform 104 is moved downwards to allow a subsequent layer of build material to be formed thereon.

The sidewalls 102 may be formed from a single sheet of material, or may be formed from individually connected sidewalls.

As illustrated in FIG. 1, the build unit 100 is divided into two portions: an upper portion 108 and a lower portion 110. The upper portion 108 is designed such that, in use, build material in the upper portion 108 of the build unit 100 is maintained within a predetermined temperature range. The lower portion 110 is designed so as to allow natural cooling of build material within the lower portion 110. By natural cooling is meant cooling primarily due to heat losses to the outside of the build unit, for example through the sidewalls and/or a build platform. In other examples, the lower portion 110 can be mechanically cooled.

As will be described below in further detail, in one example the upper portion 108 may have a lower cooling rate than the lower portion 110. In one example, the upper portion 108 may have a lower thermal conductivity than the lower portion 110. For example, the upper portion 108 may comprise thermal insulation, or may be constructed from a material having a lower thermal conductivity than the material used for the lower portion 110. The thermal conductivity of the upper portion 108 may be chosen such that, in use, build material in the upper portion 108 is maintained within a predetermined temperature range. In one example, the lower portion comprises no thermal insulation.

In a further example, the cooling rate of the upper portion 108 may be zero, or close to zero. For example, the upper portion 108 may comprise a heater to apply heat to build material in the upper portion 108. By applying heat in a controlled manner, when in use, build material in the upper portion 108 may be maintained within a predetermined temperature range. In one example the predetermined temperature range may be chosen such that the temperature of the layers of build material within the upper portion 108 are maintained with little or no cooling. In one example the heater may be supplied with a continuous electrical current to provide a predetermined amount of heat energy. In other example the heater may be supplied with a discontinuous electrical current to provide an average predetermined amount of heat energy. The amount of heat energy to be supplied by the heaters may be determined, for example, by taking into account the heat flows from the top of the build unit, from the sidewalls of the build unit, and from the build platform of the build unit. The amount of heat energy may thus be chosen such that the temperature of build material within the upper portion is maintained within a predetermined temperature range. In one example the lower portion 110 comprises no heater. In one example, the heater may be operated in a closed-feedback loop, for example using a thermal sensor positioned in an appropriate location.

In a further example, the upper portion 108 may comprise both a heater and have a lower thermal conductivity than the lower portion 110. In one example the lower portion 110 comprises neither thermal insulation nor a heater.

In a yet further example, the upper portion 108 and lower portion 110 may not have a distinct or ‘hard’ boundary. For example, the build unit may be designed such that the thermal conductivity of the upper portion 108 gradually reduces as it reaches the lower portion 110. This may be achieved, for example, through the choice of materials used for the sidewalls, or, for example, through use of a varying thickness of thermal insulation.

The build unit 100 of FIG. 1 may be provided as a stand-alone build unit, for example as a build unit that is movable between a 3D printing system and a build material management station.

Referring now to FIG. 2, there is a shown an example of a 3D printing system 200 incorporating a build unit such as the build unit 100 of FIG. 1. The 3D printing system 200 comprises a build material forming module 202 to form successive layers of build material on the build platform 104. A first layer of build material is formed directly on the build platform 104, whereas subsequent layers are formed on a previously formed layer. The build material forming module may comprise, for example, a build material distribution module, such as a hopper, to form a volume of build material adjacent to the build unit 100, and a recoater module for spreading the formed volume of build material over the build platform. In one example the recoater module may comprise a roller or a wiper.

The 3D printer 200 also comprises a selective solidification module. In one example this may comprise one or multiple printheads to print patterns of a fusing agent onto a formed layer of build material and may additionally comprise a fusing lamp to apply thermal energy to a layer of build material to cause build material where fusing agent has been applied to fuse. In a further example a preheating or warming lamp or heater may be provided to pre-heat build material to temperature close to its melting point, for example within 5 to 10 degrees Celsius of the melting point.

In another example the selective solidification module 204 may comprise a laser to selective sinter of fuse portions of each layer of build material.

Operation of the 3D printer 200 is controlled by a 3D printer controller 206. The controller 206 may control elements of the 3D printer to form layers of build material on the build platform 104 and to selectively solidify portions of each formed layer of build material.

Referring now to FIG. 3, there is shown a portion of a build unit 300 according to one example. The build unit 300 comprises an upper portion 304 and a lower portion 306. A magnified portion of a corner of the build unit 300 shows the upper portion 304 in greater detail. In this example, the upper portion 304 comprises a heater 308, thermal insulation 310, and a covering plate 312 that may, in some examples, be omitted. In the example shown the heater 308 and thermal insulation 310 may be arranged continuously around the perimeter of the upper section 304. In other examples, however, the heater 308 and/or the thermal insulation 310 may be arranged in a non-continuous manner, for example wherein sections of the upper portion 304 of the build unit comprise no heater and/or no thermal insulation. The heater 308 may, for example, have a constant or a variable shape around the perimeter of the build unit 300, for example to supply a constant or a variable power density. Use of a heater providing a variable power density may be useful, for example, where the heat loss at different points around the perimeter of the upper portion of the build unit are not constant.

In one example the heater 308 may be a strip heater, for example comprising at least one resistive heating element to, under control of a 3D printer controller, provide heat to maintain build material within the upper section 304 within a predetermined average temperature range. For example, a PA12 build material may be maintained within a temperature range of about 155 to 160 degrees Celsius.

A heat insulating seal 314 may, in one example, also be provided to provide both a powder seal, between the build unit 300 and a portion of a 3D printer into which the build module is insertable or is fixed. The heat insulating seal 314 may also help prevent, or at least reduce, heat energy provided by the heater 308 from flowing into the 3D printer. In one example the seal may be a silicone seal.

In one example, the build unit 300 may be attachable to a 3D printer by way of one or multiple mechanical connectors 316. As shown in FIG. 3, in one example the mechanical connectors 316 may be positioned below the level or height of the heater 308 to prevent, or at least reduce, heat flow into the 3D printer.

FIG. 4 shows representative net heat flow at various locations within a build unit according to one example. The illustration of FIG. 4 shows a vertical cross section through the example build unit 300 shown in FIG. 3. The build unit 300 comprises a vertically movable build platform 104 which is movable using a suitable movement mechanism, such as a piston (not shown). The build unit 300 comprises an upper section 304 and a lower section 306. The dotted shading represents layers of build material within the build unit 300. The arrows represent relative heat loss at different locations within the build unit. Longer arrows represent a higher heat loss than shorter arrows.

In the example shown, the net heat flow through the sidewalls of the upper section 304 is negative (or flows into the build material) since the heater 308 (shown in FIG. 3) provides heat to the build material in the upper section 304.

A relatively small amount of heat 404 may also flow out of build material at the bottom section of the upper portion, although the relative amount may vary depending on the type of build material used. For example, many thermoplastic type build materials have a relatively low thermal conductivity.

The net heat flow 406 out of the top of the build unit may, in some examples, also be quite small. This is since the thermal losses from the upper layers of the build material in the build unit 300 are offset by thermal energy applied during a printing operation. For example, thermal energy may be applied to the top layer of build material from one or more of a fusing lamp, a warming lamp, a laser, or the like.

Accordingly, the average temperature of build material within the upper section 304 may be maintained within a predetermined temperature range.

The net heat flow through the sidewalls of the lower section 306, however, is relatively high. As described above, this is due to the high thermal conductivity of the lower potion 404. The net heat flow through the build platform 104 may be similar, in some examples, to the heat flow through the sides of the lower section 306. This is to enable build material in the lower section 306 to cool relatively rapidly, for example using natural cooling.

The height of the upper portion may be chosen, for example, to allow build material therein to be maintained with a predetermined temperature range for a predetermined length of time. This may allow, for example, improved reptation of build material structures that help improve, for example, interlayer strength. For example, consider a 3D printer that has a build material layer processing time of 10 seconds (i.e. the time it takes to form a layer of build material and to selective solidify a portion of each layer), and that forms and processes layers of build material having a thickness of 100 microns. The time, thus, to process 1 cm of build material (or 100 layers of build material) will be around 17 minutes. Therefore, if the height of the upper portion 304 is chosen to be 1 cm, each processed layer of build material will be maintained within the predetermined temperature range for around 17 minutes before significant cooling of that layer may start.

Thus, depending on the particular build material(s) to be used within the 3D printer the height of the upper portion 304 may be chosen accordingly. In one example, where removable build units are provided, different build units may have different upper portion 304 heights based on properties of a build material with which they are intended to be used. For example, in one example the upper portion 108 may have a height of about 1 cm, or about 2 cm, or about 3 cm, or about 4 cm, or about 5 cm, or about 6 cm, or about 7 cm, or about 8 cm, or about 9 cm, or about 10 cm.

It should be appreciated that FIG. 4 and the related description show and describe a somewhat simplified view of heat flow for the purposes of understanding principles of the examples described herein.

Referring now to FIG. 5, there is shown a portion of a build unit 500 according to one example. The build unit 500 comprises an upper portion 304 and a lower portion 306. A magnified portion of a corner of the build unit 500 shows the upper portion 304 in greater detail. In this example, the upper portion 304 comprises a heater 308. It should be noted that in this example there is no thermal insulation provided around the heater 308. In one example the covering plate may also be omitted.

Referring now to FIG. 6, there is shown a portion of a build unit 600 according to one example. The build unit 600 comprises an upper portion 304 and a lower portion 306. A magnified portion of a corner of the build unit 600 shows the upper portion 304 in greater detail. In this example, the upper portion 304 comprises a thermal insulation 310 and cover plate 312. In one example the cover plate 312 may be omitted. The thermal insulation 310 decreases the thermal conductivity of the upper portion 304, as described above allowing the predetermined temperature range to be maintained in the upper portion 304. Although in FIG. 6 the thermal insulation 310 is provided in addition to the sidewalls of the build unit 600, in other examples the thermal insulation may be incorporated into the sidewalls, for example by choice of materials used to construct the sidewalls,

In one example the sidewalls of a build unit may be constructed of steel, for example from sheet steel. The steel may be chosen to have a thermal conductivity of about 60 W/mK (watts per meter kelvin). In another example the sidewalls may be constructed of stainless steel, for example from sheet stainless steel. The stainless steel may be chosen to have a thermal conductivity of above 15 W/mk. In other examples other materials having other suitable thermal conductivities may be chosen.

A method of operating a 3D printing system according to one example is shown in FIG. 7. The operations may be performed, for example, by elements of the 3D printing system illustrated in FIG. 2.

At block 702 the 3D printing system is controlled to form and thermally process successive layers of build material in a build unit. By thermally process is meant using a thermal selective solidification system to cause selective heating, melting, sintering, of portions of each layer of build material formed.

At block 704, the 3D printing system, by way the construction of the build unit, as described above, allows a top portion of the build unit to have a first cooling rate, or to maintain the top portion of the build unit within a predetermined temperature range.

At block 706, the 3D printing system, by way of the construction of the build unit, as described above, allows a bottom portion of the build unit to have a second cooling rate to allow effective cooling of build material within the bottom portion of the build unit. Depending on the materials chosen for the construction of the bottom portion of the build unit this may enable a rapid cooling of build material in the bottom portion, whilst ensuring that recently processed portions of build material in the top portion are maintained within a predetermined temperature range for a predetermined length of time.

In one example when a 3D object has been generated in the build unit, for example once a 3D print job has been executed, the 3D printer may be controlled to continue to add layers of build material on the build platform, such that the top layers of the 3D print job remain within the upper portion of the build unit for the same length of time as the lower layers of the 3D print job. For example, if the top portion has a height of 1 cm the 3D printing system may be controlled to add 100 layers of 100 micron thick layers after completion of the 3D printed object. This helps ensure that the properties of the 3D printed object are substantially homogeneous, at least in terms of reptation.

In another example, the 3D printer may be controlled not to add additional layers of build material after completion of the 3D printed object, but to lower the build platform of the build unit at the same rate as during processing of a 3D print job. In other words, the 3D printer controller 206 may control the build platform 104 to be lowered by 100 microns every 10 seconds until the build platform 104 has been lowered at least 100 times (representing 100 layers of build material).

In further examples, once a 3D object has been formed in a build unit, accelerated or forced cooling techniques may be used to further accelerate cooling of the contents of the build unit. For example, forced cooling may be applied after completion of a 3D print job once the last formed object layers have been maintained for a predetermined time within the upper portion of the build unit, as described above, Forced cooling may comprise, for example, introduction of ambient or cooled airflows into the build unit, removal of unfused build material from the build unit. In this way, after completion of a 3D print job all layers of a formed 3D object within the build unit will have been maintained within the predetermined temperature range for the predetermined length of time and may be forcefully cooled without affecting the quality of the printed 3D objects. This enables high quality 3D printed objects to be printed and be made available to a user, after cooling, in a satisfactory time.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A build unit for a 3D printer, comprising:
a housing and a build platform movable with the housing, the housing and the platform forming a build chamber;
wherein an upper portion of the housing is to, during a print operation, maintain the contents of the upper portion of the build chamber within a first predetermined temperature range; and
wherein the lower portion of the housing is to allow cooling of the contents of a lower portion of the build chamber.

2. The build unit of claim 1, wherein the upper portion comprises a heater controllable to apply heat to the upper portion of the build chamber.

3. The build unit of claim 1, wherein the upper portion comprises thermal insulation to reduce lateral heat loss from the contents of an upper portion of the build chamber.

4. The build unit of claim 1, wherein the upper portion comprises a heater controllable to apply heat to the upper portion of the build chamber and thermal insulation to reduce relative lateral heat loss from the contents of an upper portion of the build chamber.

5. The build unit of claim 1, wherein the lower portion of the housing is to allow natural cooling of the contents of a lower portion of the build chamber.

6. The build unit of claim 1, wherein the housing is formed from sheet metal having a thermal conductivity of less than about 150 W/mk.

7. The build unit of claim 1, wherein the upper portion comprises up to about the upper 100 mm of the build chamber, and wherein the lower portion comprises the portion of the build chamber below the upper portion.

8. The build unit of claim 1, wherein the housing is a generally open-topped housing.

9. The build unit of claim 2, further comprising at least one mechanical connector to connect the build unit to a 3D printer, wherein the at least one mechanical connector is positioned below the height of the heater.

10. The build unit of claim 2, further comprising a seal to form a powder seal and provide thermal insulation between the top of the build unit and a 3D printer.

11. A three dimensional printer comprising:
a build unit comprising a build platform movable with the housing, the housing and the platform forming a build chamber, wherein an upper portion of the build unit is to, during a print operation, maintain the contents thereof within a first predetermined temperature range, and wherein the lower portion of the build unit is to allow cooling of the contents thereof.

12. The three dimensional printer of claim 11, wherein the upper portion of the build unit comprises at least one of: a heater; and thermal insulation.

13. The three dimensional printer of claim 11, further comprising:
a build material forming module to form successive layers of build material on the build platform; and
a selective solidification module to selectively thermally solidify portions of each formed layer of build material.

14. The three dimensional printer of claim 11, wherein the upper portion of the build unit comprises at least one of a: a heater; and thermal insulation.

15. A method of operating a three-dimensional printer, comprising:
forming and thermally processing successive layers of build material in a build unit;
allowing a top portion of the build unit to have a first cooling rate; and
allowing a lower portion of the build unit to have a second cooling rate higher than the first cooling rate.
